(19) United States
(12) Patent Application Publication
(10) Pub. No.: US 2025/0057326 A1
(43) Pub. Date: Feb. 20, 2025

(54) MATTRESS ASSEMBLIES INCLUDING BLENDS OF PHASE CHANGE MATERIAL TO MITIGATE SUPERCOOLING EFFECTS

(71) Applicant: Dreamwell, Ltd., Doraville, GA (US)

(72) Inventor: Christopher Francis Chunglo, Marietta, GA (US)

(21) Appl. No.: 18/805,066

(22) Filed: Aug. 14, 2024

Related U.S. Application Data
(60) Provisional application No. 63/519,981, filed on Aug. 16, 2023.

(51) Int. Cl. A47C 27/08; A47C 21/04; A47C 27/14

(52) U.S. Cl. CPC A47C 27/085; A47C 21/046; A47C 27/142

(57) ABSTRACT

Mattress assemblies include at least one layer or a portion thereof including a preformed flexible and liquid impermeable capsulate completely encapsulating a bulk blend of phase change materials. The bulk blend of phase change materials include a low phase change transition temperature material configured to transition between a solid and a liquid during use, and high phase change transition temperature material configured to maintain crystallinity during use. Also disclosed are processes for forming the microencapsulated blend of phase change materials.

### CROSS REFERENCE TO RELATED APPLICATIONS

The present application claims the benefit of U.S. Provisional Application No. 63/519,981, filed on Aug. 16, 2023, incorporated herein by reference in its entirety.

### BACKGROUND

The present disclosure generally relates to mattress assemblies including phase change materials, and more particularly, to mattress assemblies including blends of phase change material configured to minimize and/or prevent supercooling of the phase change materials during use in mattress assemblies.

Phase change is a term used to describe a reversible process in which a solid turns into a liquid or a gas. The phase change process from a solid to a liquid requires energy to be absorbed by the solid. When a phase change material (“PCM”) liquefies, energy is absorbed from the immediate environment as it changes from the solid to the liquid. In contrast to a sensible heat storage material, which absorbs and releases energy essentially uniformly over a broad temperature range, a phase change material absorbs and releases a large quantity of energy in the vicinity of its melting/freezing point. Therefore, for mattress applications, a PCM that melts below body temperature would feel cool as it absorbs heat, for example, from contact with an end user's body. PCMs, therefore, include materials that liquefy (melt) to absorb heat and solidify (freeze) to release heat. The melting and freezing of the material typically take place over a relatively narrow temperature range.

PCMs have been used in various applications ranging from household insulation to clothing. Dispersal in pre-formed foams is expensive, involves an additional step after formation of the foam, and typically does not uniformly distribute the PCMs throughout foams greater than one inch in thickness. In these types of applications, the PCM is microencapsulated. Typically, the PCM material itself is a relatively inexpensive long chain hydrocarbon. However, the microencapsulation process dramatically increases the price of the PCM. As one decreases the overall size of the microencapsulated PCM, the net volume of the PCM within the microencapsulated PCM significantly decreases whereas the volume taken up by the capsule increases.

### BRIEF SUMMARY

Disclosed herein are mattress assemblies including at least one layer or a portion thereof comprising a preformed flexible and liquid impermeable capsulate completely encapsulating a bulk blend of phase change materials, wherein the blend of phase change materials comprise a low phase change transition temperature material configured to transition between a solid and a liquid during use, and high phase change transition temperature material configured to maintain crystallinity during use.

In one or more embodiments, a process for forming a microencapsulated blend of phase change materials for mattress assemblies includes selecting a low temperature phase change transition material having a phase change transition temperature of about 22° C. to about 36° C., wherein the low temperature phase change transition material is at least partly unsaturated. The low temperature phase change transition material is hydrogenated to increase a melting/freezing temperature and provide a high low temperature phase change transition material. A blend of the low temperature phase change transition material with the high temperature phase change transition material is encapsulated in a preformed capsulate wherein the melting/freezing temperature of the high temperature phase change transition material is configured to remain crystalline during use in the mattress assemblies, and the low temperature phase change transition material is selected to transition between a solid phase and a liquid phase during use and non-use of the mattress assemblies.

The disclosure may be understood more readily by reference to the following detailed description of the various features of the disclosure and the examples included therein.

### BRIEF DESCRIPTION OF THE DRAWINGS

Referring now to the figures wherein the like elements are numbered alike:

Figure (“FIG.”) 1 illustrates a cross-sectional view of a mattress assembly including at least one layer including a macroencapsulated phase change material containing a bulk amount of phase change material within a pre-formed capsulate, wherein the phase change material is not microencapsulated in accordance with an embodiment of the present disclosure; and

FIG. 2 illustrates of the macroencapsulated phase change material of FIG. 1 in accordance with an embodiment of the present disclosure.

### DETAILED DESCRIPTION

Phase change materials (PCMs) can undergo a phenomenon referred to as supercooling, which is a natural phenomenon that keeps a PCM in its liquid state at a temperature lower than its solidification temperature. This means that the PCM must go below its normal recrystallization temperature before crystallization can occur. In mattress applications, supercooling can deleteriously alter the effectiveness of the PCM since after providing a cooling effect to an end user as a function of its transition from the solid phase to the liquid phase during a sleep cycle, the bulk PCM can stay in the liquid state for an extended period of time in order to fully recrystallize to the solid state. The problem is exacerbated in mattress applications that include macroencapsulated PCMs containing bulk amounts of PCM within a pre-formed capsulate in mattress assemblies, wherein the bulk amount of PCM is on the order of multiple grams per square foot of the PCM. The delay in crystallization from the liquid phase to the solid phase as a consequence of supercooling will impact its subsequent cooling effectiveness if the time interval between use of the mattress assembly by the end user is less than the time needed for recrystallization of the bulk PCM within the preformed capsulate to fully occur.

Disclosed herein are mattress assemblies including at least one layer or portions thereof including a macroencapsulated blend of phase change materials (PCMs), wherein the PCM blend includes at least one PCM having a phase change transition temperature higher than another PCM in the blend, which can effectively minimize or prevent supercooling. As will be described in greater detail below, the at least one PCM having the higher phase change transition temperature remains crystalline during use and non-use of the mattress assembly whereas the PCM having the lower phase transition temperature is configured to transition from the solid state to the liquid state during a sleep cycle or other use to provide a cooling effect to the end user. The presence of the higher phase change transition temperature PCM in its crystalline functions as a seed material to promote recrystallization of the PCM with the lower phase change transition temperature when at or below the solidification temperature. In this manner, the effects of supercooling with the PCM with the lower phase change transition temperature are diminished or prevented.

As used herein, the term “macroencapsulated PCM blend” refers to encapsulation of a bulk amount of the PCM blend in a preformed capsulate, which can be on the order of at least about 50 grams per square foot or more. In contrast, microencapsulated PCMs, which have traditionally been integrated into foam layers and fabric to provide the cooling effect in mattress applications, are typically on the order of few grams or milligrams per square foot Microencapsulated PCMs generally include a polymeric or inorganic shell configured to encapsulate and prevent leakage of a relatively small amount of PCM during use, wherein the shell is substantially spherically-shaped having diameters of several nanometers to several microns. In the present disclosure, the macroencapsulated PCM blend includes a preformed capsulate having an interior significantly larger than the several microns utilized with microencapsulated PCMs. The pre-formed capsulate can take a variety of forms and shapes and can span the entire layer of a mattress or a portion thereof, wherein the preformed capsulate contains a bulk amount of the PCM blend, which depending on the intended application and configuration, can encapsulate hundreds to thousands of grams of the PCM blend and further include additional materials, e.g., foams, fibers, thermally conductive additives, fire retardants, dyes, and the like.

In one or more embodiments, the phase change materials in the blend can be selected to have phase transition temperatures within a range of about 22° to about 36° C., wherein at least one of the phase change materials has a higher melting/freezing temperature that is generally maintained in crystalline form during periods of use and non-use of the mattress application. In one or more embodiments, the phase change materials with the higher melting/freezing temperature have a similar structure to the lower melting phase change material. In contrast, the lower melting/freezing phase change material is selected to undergo a phase change at temperatures experienced during use to provide the cooling effect whereas the higher melting phase change material remains crystalline at the temperatures experienced during use so as to minimize and/or prevent supercooling. In one or more other embodiments, the lower melting phase change material can have a transition temperature within a range of about 25° C. to about 30° C.

In one or more embodiments, the PCM(s) including the lower phase change transition temperature is greater than 99 to less than 100 weight percent of the blend; greater than 95 to less than 100 weight percent in other embodiments, and greater than 75 to less 100 percent in still other embodiments although lower amounts can be used with the remainder being the higher melting/freezing phase change material. As noted above, the PCM including the higher phase change transition temperature has a transition temperature greater than the actual temperature experienced by the macroencapsulated blend of phase change materials during use in the mattress assembly so as to maintain crystallinity during use. The presence of the crystalline form of the higher melting/freezing temperature PCM thermodynamically promotes crystallization of the lower melting/freezing temperature PCM, which minimizes and/or prevents the length of time the lower melting phase change material is in liquid form at a temperature lower than or equal to its solidification temperature as a consequence of supercooling during non-use.

By way of example, natural coconut oil, which can be utilized as a phase change material, has a melting/freezing temperature of about 76° F., which is at slightly above room temperature. Use of bulk amounts of natural coconut oil by itself in a preformed capsulate can provide effective cooling to an end user during a sleep cycle, for example, which can result in the natural coconut oil fully transitioning from the solid state to the liquid state upon completion of the sleep cycle, which could be 8 hours or more. However, once in the liquid state, the natural coconut oil must transition back to the solid state in order to provide effective cooling in a subsequent sleep cycle. Recrystallization before the bulk amount of natural coconut oil fully releases all of the thermal energy absorbed during the sleep cycle and transition back to the solid state can take a considerable amount of time especially when in bulk form, which ideally occurs prior to the next sleep cycle. Supercooling can affect and prolong the period of time for recrystallization. Because of this, the effectiveness of natural coconut oil by itself may not be consistent day-to-day if the period of time for recrystallization between sleep cycles is not sufficient to fully recrystallize the natural coconut oil.

In the present disclosure, a higher melting/freezing phase change material is included in the blend with the natural coconut oil, for example, to provide spontaneous crystallization of the lower melting/freezing PCM. In a non-limiting example using natural coconut oil, a relatively small amount of a saturated coconut oil can be blended with the natural coconut oil. Saturated coconut oil has a melting/freezing temperature of about 92° F., which is well above room temperature and is likely to remain crystalline during periods of use and non-use in the mattress assembly because the transition temperature is likely to be greater than the actual temperature received by the PCM from the end user's body temperature during use.

It should be noted that placement of the macroencapsulated phase change material can affect the actual temperature that the microencapsulated PCM is exposed. Typically, the microencapsulated PCM is placed below the sleeping surface. As you go down in the construction of a mattress, i.e., away from the sleeping surface, the actual temperatures generated by a prone body on sleeping surface at those distant locations decrease. By way of example, at a distance of about one-half inch from the sleeping surface, which may occur from the presence of a thin viscoelastic layer as an uppermost layer in the mattress construction, the maximum actual temperature at that location from during use is about 90° F., which is below the melting point of the saturated coconut oil. As such, the saturated coconut oil would not typically transition from the solid phase to the liquid phase during use if the temperature did not exceed 92° F. Instead, the saturated coconut oil would remain crystalline and provide no cooling activity since no phase change transition would occur. Cooling would be provided only by the natural coconut oil given its lower melting/freezing temperature upon transition from the solid phase to the liquid phase. However, because the saturated coconut oil remains crystalline during use, supercooling would be minimized since the saturated coconut would advantageously promote recrystallization of the natural coconut oil during periods of non-use.

For the purposes of the description hereinafter, the terms “upper”, “lower”, “top”, “bottom”, “left,” and “right,” and derivatives thereof shall relate to the described structures, as they are oriented in the drawing figures. The same numbers in the various figures can refer to the same structural component or part thereof. Additionally, the articles “a” and “an” preceding an element or component are intended to be nonrestrictive regarding the number of instances (i.e. occurrences) of the element or component. Therefore, “a” or “an” should be read to include one or at least one, and the singular word form of the element or component also includes the plural unless the number is obviously meant to be singular.

Spatially relative terms, e.g., “beneath,” “below,” “lower,” “above,” “upper,” and the like, can be used herein for ease of description to describe one element or feature's relationship to another element(s) or feature(s) as illustrated in the figures.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

As used herein, the term “about” modifying the quantity of an ingredient, component, or reactant of the invention employed refers to variation in the numerical quantity that can occur, for example, through typical measuring and liquid handling procedures used for making concentrates or solutions. Furthermore, variation can occur from inadvertent error in measuring procedures, differences in the manufacture, source, or purity of the ingredients employed to make the compositions or carry out the methods, and the like.

It will also be understood that when an element, such as a layer, region, or substrate is referred to as being “on” or “over” another element, it can be directly on the other element or intervening elements can also be present. In contrast, when an element is referred to as being “directly on” or “directly over” another element, there are no intervening elements present, and the element is in contact with another element.

Referring now to FIG. 1, there is depicted a cross-sectional view of a mattress assembly including a cover layer 12, a layer 14 representative and exemplary of the at least one layer including a macroencapsulated bulk blend of PCMs underlying the cover layer 12, and a mattress body 16 underlying layer 14.

The illustrated layer 14 overlies the mattress body 16 and is depicted as being generally parallelpiped-shaped having a length (L) dimension and a width (W) dimension that can be configured to approximate the length and width dimensions of the mattress body 16. The illustrated layer of the macroencapsulated bulk blend of PCMs 14 generally has a thickness equal to or less than 6 inches in one or more embodiments, a thickness equal to or less than 5 inches in other embodiments, or a thickness equal to or less than 4 inches in still other embodiments. In other embodiments, the thickness is greater than or equal linch.

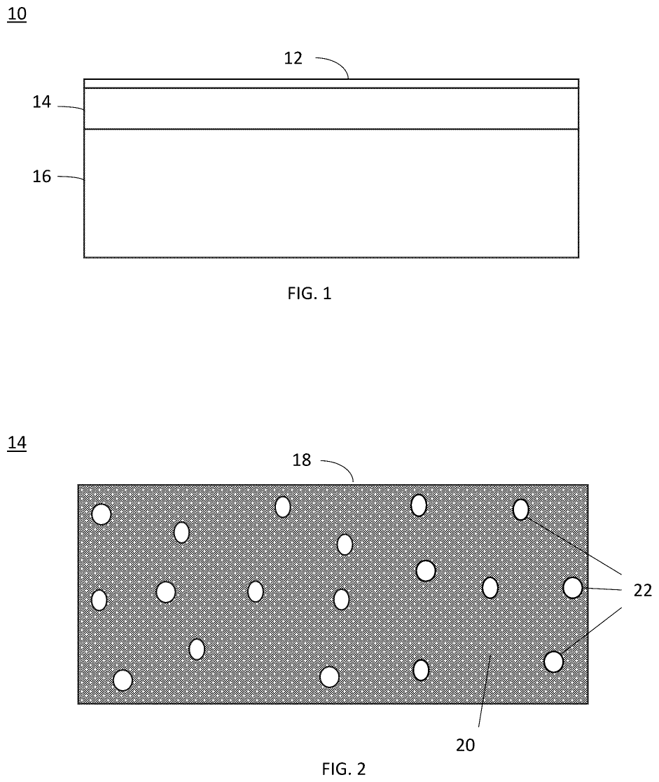

FIG. 2 depicts and enlarged cross section view of the exemplary layer 14 including the macroencapsulated bulk blend of PCMs by itself. The layer 14 of the macroencapsulated bulk blend of PCMs includes a preformed capsulate 18 formed of a liquid impermeable and flexible material, which completely encapsulates the bulk blend of PCMs, which includes a low temperature phase change PCM 20 selected to undergo phase transition during use in the mattress assembly and a high temperature phase change PCM 22 selected to remain crystalline during use and non-use in the mattress assembly. Although the encapsulated bulk blend of phase change materials is shown defining layer 14 in its entirety, it should be apparent that the encapsulated bulk blend of phase change materials can be configured to span a portion thereof, when the remainder can be foam, e.g., one or more channels can be formed in the foam layer and the microencapsulated blend of phase change materials can be disposed at least partially within the one or more channels. In this manner, the mattress assembly can be configured to provide zones including the macroencapsulated bulk blend of PCMs. Advantageously, the macroencapsulated bulk blend of phase change materials provides extended cooling as needed to an end user of the mattress assembly 10 compared to microencapsulated PCMS that generally provide less than 1 hour of cooling effect and minimizes or prevents supercooling of the low melting/freezing phase change material in the blend (e.g., PCM 20) as previously described In one or more embodiments, the preformed capsulate 18 can further include a permeable resilient material (not shown) such as an open cell foam and/or fibers disposed therein, wherein the permeable material can be infused with the bulk phase change material or materials and inserted into the preformed capsulate prior to sealing of the capsulate 18.

Referring to the mattress assembly of FIG. 1, the cover layer 12 is the uppermost layer in the mattress assembly 10 and has a planar top surface adapted to substantially face a user resting on the mattress assembly. The cover layer 12 overlays layer 14 and generally has length and width dimensions sufficient to support a reclining body of the user. The cover layer 12 is not intended to be limited and can be formed of foam, fibers, mixtures thereof, a macro- or microencapsulated PCM layer (in addition to or in the absence of layer 14), or the like. In one or more embodiments, the cover layer can be formed from viscoelastic foam or non-viscoelastic foam depending on the intended application. The foam itself can be of any open or closed cell foam material including without limitation, latex foams, natural latex foams, polyurethane foams, combinations thereof, and the like. The thickness of the cover layer is generally within a range of about 0.5 to 2 inches in some embodiments, and less than 1 inch in other embodiments so as to provide the extended cooling benefits of the underlying layer 14 including the microencapsulated blend of PCMs. The density of the cover layer 12 can be within a range of 1 to 8 lb/ft³ in some embodiments, and 2 to 4 lb/ft³ in other embodiments. The hardness is within a range of about 7 to 28 pounds-force in some embodiments, and less than 15 pounds-force in other embodiments. In one or more embodiments, the cover layer 12 can be configured as a quilt panel or a convoluted foam.

The cover layer 12 and the layer 14 including the at least one microencapsulated blend of PCMs collectively overlie the mattress body 16. The mattress body 16 is not intended to be limited and can include one or more layers including foam layers, fiber layers, coil layers, air bladders, various combinations thereof, and the like as is generally known in the art. Generally, the mattress body 16 can have a thickness be greater than 4 inches to less than 12 inches although greater or lesser thicknesses can be used. Suitable foam layers include, without limitation, synthetic and natural latex, polyurethane, polyethylene, polypropylene, and the like. Optionally, in some embodiments, one or more of the foam layers may be pre-stressed such as is disclosed in U.S. Pat. No. 7,690,096, incorporated herein by reference in its entirety. The coil layers generally include coil springs are not intended to be limited to any specific type or shape. The coil springs can be single stranded or multi-stranded, pocketed or not pocketed, asymmetric or symmetric, and the like. It will be appreciated that the pocket coils may be manufactured in single pocket coils or strings of pocket coils, either of which may be suitably employed with the mattresses described herein. The attachment between coil springs may be any suitable attachment. For example, pocket coils are commonly attached to one another using hot-melt adhesive applied to abutting surfaces during construction.

The mattress assembly 10 can further include a side rail assembly (not shown) about all or a portion of the perimeter of at least by the mattress body 16 and optionally the cover layer 12 and the layer including the macroencapsulated bulk blend of PCMs 14. In some embodiments, the cover layer 12 and the layer including the macroencapsulated blend of PCMs 14. overlay the mattress body and the side rail assembly. The side rails that define the assembly may be attached to or placed adjacent to at least a portion of the perimeter of the mattress body 16, and may include metal springs, spring coils, encased spring coils, foam, latex, natural latex, latex w/gel, gel, viscoelastic gel, fluid bladders, or a combination thereof, in one or more layers. The side rails may be placed on one or more of the sides of the mattress body 16, e.g., on all four sides, on opposing sides, on three adjacent sides, or only on one side. In certain embodiments, the side rails may comprise edge supports with a firmness greater than that provided by the mattress body 16. The side rails may be fastened to the stacked mattress layers via adhesives, thermal bonding, or mechanical fasteners.

For case in manufacturing the mattress assembly, the side rail assembly may be assembled in linear sections that are joined to one another to form the perimeter about the mattress layers. Alternatively, the ends may be mitered or have some other shape, e.g., lock and key type shape.

As noted above, phase change materials are relatively inexpensive whereas the cost to manufacture prior art microencapsulated phase change materials are relatively high since the encapsulation material has a high surface area relative to the amount of phase change material contained within each cell. In contrast, the macroencapsulated bulk blend of phase change materials of the present disclosure provide a markedly higher volume of phase change material(s) within the capsulate material that lowers the surface area of the capsulate material relative to the amount of phase change material, thereby providing a significant cost reduction. In this manner, instead of milligrams to grams of phase change material within a given layer as is currently done in the prior art, the present disclosure advantageously provides the capability of utilizing hundreds of grams or pounds of a blend of phase change materials within a given layer or portion of a layer as may be desired for different applications. Advantageously, the increased amount of phase change material can be configured to extend the effective solid state to liquid state transition time of the lower melting/freezing phase change material throughout an entire sleep cycle of 8 hours or more, which is unlike prior art microencapsulated phase change layers that generally provide an effective transition time of a few minutes to about 30 minutes. However, because a bulk amount of phase change material is utilized, recrystallization can take an extended time to fully transition back to the solid state. The presence of the higher melting/freezing phase change material can accelerate recrystallization of the lower melting/freezing phase change material by providing seed crystals, which can minimize or prevent supercooling.

The macroencapsulated bulk blend of phase change materials is not intended to be limited to any particular geometric shape. In one or more embodiments, the macroencapsulated bulk blend of phase change materials can be composed of a single sealed cell. In one or more other embodiments, the encapsulated bulk phase change material can be formed of multiple interconnected cells fluidly connected to one another, and in still one or more other embodiments, the macroencapsulated bulk blend of phase change materials can be formed of multiple discrete cells. In the case of a single sealed cell, interconnected cells, or multiple individual discrete cells, the cellular volumes are generally greater than 1 cm³. Generally, as it relates to the size, spatial volume, and shape of the cell, the amount of phase change material contained therein is effective to provide a phase transition time to the end user of at least about 30 minutes or greater. In contrast, prior art microencapsulated phase change materials for bedding applications are generally on the order of a few grams or micrograms per square foot.

The optional permeable material in the performed capsulate can be saturated with the blend of phase change materials while in a liquid state, inserted into an opening of the capsulate material, and then sealed. This would help the layer keep its shape when the lower melting/freezing phase change material(s) changes to its liquid state. Without the addition of a permeable material such as an open cell foam when the phase change material or materials changes state to a liquid it would naturally migrate to the side away from the pressure of a reclining body. The addition of the foam and/or fiber will ensure there is a level of support being provided by the layer even after the lower melting/freezing phase change material or materials transitions to a liquid state.

In one or more embodiments, the amount of phase change material in the encapsulated bulk phase change material is at least 50 grams per square foot of surface area, greater than about 100 grams per square foot in other embodiments, and greater than about 400 grams per square foot in still other embodiments, or more in yet other embodiments.

The pre-formed capsulate 18 can be formed of a liquid impermeable and flexible material such as polyethylene or the like, which can be filled with the bulk amount blend of phase change materials, and optionally foam, fiber, and/or other permeable material. Still further, additional material(s) such as flame retardants, antibacterial agents, thermally conductive components, and/or the like can be included within the pre-formed capsulate 18. In one or more embodiments, the pre-formed capsulate material 18 further includes a thermally conductive material.

By way of example, the pre-formed capsulate 18 can be formed from two-ply sheets of a resilient and flexible material such as polyethylene and is selected to be compatible with the intended phase change material(s) to be used. As used herein, the term “two-ply” generally refers to two separate sheets, first and second sheets, that are bonded at peripheral edges thereof to form the capsulate sheet. The individual sheets themselves that define the two-ply capsulate sheet configuration can be formed from a single layer or multiple layers as may be desired for desired strength and resiliency.

Phase change materials that can be incorporated in the pre-formed capsulate in accordance with various embodiments of the disclosure generally include unsaturated hydrocarbons, bio-phase change materials derived from fatty acids and their derivatives, e.g., alcohols, amines, esters, and the like, wherein the degree of hydrogen saturation within the material can be readily changed via hydrogenation. In the process of hydrogenation, unsaturated fats (monounsaturated and polyunsaturated fatty acids) are combined with hydrogen in a catalytic process to increase saturation, which can increase the melting/freezing temperature. The bio-phase change materials have high latent heat, small volume change for phase transition, sharp well-defined melting temperature and reproducible behavior.

The selection of the blend of phase change materials will typically be dependent upon a desired transition temperature. For example, a phase change material having a transition temperature slightly above room temperature but below skin temperature may be desirable for mattress applications to maintain a comfortable temperature for a user.

A suitable phase change material can have a phase transition temperature within a range of about 22° to about 36° C. In one or more other embodiments, the transition temperature within a range of about 25° C. to about 30° C. Exemplary phase change materials for mattress applications include coconut fats and oils, which can be selected to have a melting temperature of 19 to 34° C.

In one or more embodiments, natural oils are utilized in the layer including the microencapsulated PCM blend having varying degrees of saturation, which can be used to tailor the phase change temperatures. Exemplary natural oils are provided in Table 1 below. As shown, natural coconut oil has 6 percent mono-unsaturated fat and 2 percent poly-unsaturated fat, which provides a melt temperature of 76° F. The percentages of unsaturated fat can be reduced by hydrogenation, which can change the melt/freeze temperature. Fully hydrogenated natural coconut oil, i.e., 100 percent saturated fat content, has an increased melt/freeze temperature of 92° F. The degree of saturation can be altered to provide a desired melt/freeze temperature between 76° F. and 92° F. For example, partial hydrogenation could shift the melt/freeze temperature to about 80 to 84° F. Generally, the larger the % of monounsaturated and the polyunsaturated fats the higher the temperature can shift upon reducing these unsaturated fats by hydrogenation. For the oils in the table below coconut oil has only 8% unsaturated while palm kernel oil has 14% and palm oil has 48%. In this manner, the melt temperatures of palm kernel oils could be shifted much more than the coconut oil.

TABLE 1

| | Melt/Freeze | Mono- | Poly- | |
|---|---|---|---|---|
| | Point | unsaturated | unsaturated | Saturated Fat |
| Fat | Temperature | fat (%) | fat (%) | (%) |
| Coconut Oil | 76 F. (25 C.) | 6 | 2 | 92 |
| Coconut Oil | 92 F. (33 C.) | 0 | 0 | 100 |
| Palm Kernel | 75 F. (24 C.) | 12 | 2 | 86 |
| Oil | | | | |
| Cocoa Butter | 75 F. (24 C.) | 20-43 | 0-5 | 57-64 |
| Palm Oil | 75 F. (24 C.) | 38 | 10 | 52 |

During manufacture of the macroencapsulated layer, the phase change material in the raw form may be provided as a solid in a variety of forms (e.g., bulk form, powders, pellets, granules, flakes, microencapsulates, and so forth) or as a liquid in a variety of forms (e.g., molten form, dissolved in a solvent, and so forth).

As noted above, the phase change material(s) is provided within the preformed capsulate, which generally consists of a flexible pouch partially filled with or without air. In one or more embodiments, the phase change material can be injected directly into a cell and subsequently sealed using a hardener or a sealing adhesive or can be thermally fused. In other embodiments, recesses are formed in a carrier sheet and subsequently filled with the desired phase change material. In one or more embodiments, the blend of phase change materials can be maintained above its melting temperature during the injection.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A mattress assembly comprising:
at least one layer or a portion thereof comprising a preformed flexible and liquid impermeable capsulate completely encapsulating a bulk blend of phase change materials, wherein the blend of phase change materials comprise a low phase change transition temperature material configured to transition between a solid and a liquid during use, and high phase change transition temperature material configured to maintain crystallinity during use.

2. The mattress assembly of claim 1, wherein the preformed capsulate further comprises a permeable material infused with the blend of phase change materials.

3. The mattress assembly of claim 2, wherein the permeable material comprises foam.

4. The mattress assembly of claim 1, wherein the low phase change transition temperature material comprises natural coconut oil and the high phase change transition temperature material comprises saturated coconut oil.

5. The mattress assembly of claim 1, wherein the blend of phase change materials have a melting point in a range of about 22° C. to about 36° C.

6. The mattress assembly of claim 1, wherein the at least one layer or the portion thereof define zones within the mattress assembly.

7. The mattress assembly of claim 1, wherein the portions thereof are provided in one or more channels provided in a foam layer, wherein the portions thereof at least partially fill the one or more of the channels.

8. The mattress assembly of claim 1, wherein the low phase change transition temperature material comprises an unsaturated hydrocarbon and the high phase change transition temperature material comprises saturated hydrocarbon.

9. The mattress assembly of claim 1, wherein the preformed capsulate further comprises a thermally conductive material.

10. A process for forming a microencapsulated blend of phase change materials for mattress assemblies, the process comprising:
selecting a low temperature phase change transition material having a phase change transition temperature of about 22° C. to about 36° C., wherein the low temperature phase change transition material is at least partly unsaturated;
hydrogenating the low temperature phase change transition material to increase a melting/freezing temperature and provide a high low temperature phase change transition material;
encapsulating a blend of the low temperature phase change transition material with the high temperature phase change transition material, in a preformed capsulate wherein the melting/freezing temperature of the high temperature phase change transition material is configured to remain crystalline during use in the mattress assemblies, and the low temperature phase change transition material is selected to transition between a solid phase and a liquid phase during use and non-use of the mattress assemblies.

11. The process of claim 10, wherein the low temperature phase change transition material comprises an unsaturated hydrocarbon.

12. The process of claim 10, wherein the low temperature phase change transition material comprises a natural coconut oil, palm oil. palm kernel oil, and/or cocoa butter.

13. The process of claim 10, wherein the low temperature phase change transition material is in an amount greater than about 75 percent to less than 100 percent of the blend.

14. The process of claim 10, wherein the preformed capsulated comprises a 2-ply construction of liquid impermeable and flexible sheets.
